(19) United States
(12) Patent Application Publication
(10) Pub. No.: US 2010/0310160 A1
(43) Pub. Date: Dec. 9, 2010

(54) IMAGE PROCESSING APPARATUS AND METHOD FOR GENERATING COLOR CONVERSION TABLE

(76) Inventor: Takehiro NAKAJIMA, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/783,928

(22) Filed: May 20, 2010

(30) Foreign Application Priority Data
Jun. 4, 2009 (JP) 2009-135272

(51) Int. Cl. G06K 9/36

(52) U.S. Cl. 382/162

(57) ABSTRACT

An input color signal is converted into an output color signal fitting into an output device with a combined color conversion table that a to-be-combined (black adjustment) color conversion table and a normal-use color conversion table depending on the output device are combined. As a unit for generating the to-be-combined color conversion table, there is provided a unit for changing an output RGB value corresponding to an input RGB value (a value close to black) determined to be in a predetermined target range of black adjustment, out of output RGB values in a dummy color conversion table in which no color conversion is made, to a value making it more blackish. The generated color conversion table is combined with the normal-use color conversion table.

### CROSS-REFERENCE TO RELATED APPLICATIONS

The present application claims priority to and incorporates by reference the entire contents of Japanese Patent Application No. 2009-135272 filed in Japan on Jun. 4, 2009.

### BACKGROUND OF THE INVENTION

1. Field of the Invention

The present invention relates to an image processing apparatus that performs a color conversion process on an input RGB-component color signal into an output color signal.

2. Description of the Related Art

Conventionally, digitalization of an image is performed by software for creating image data installed on an imaging device, such as a scanner for reading an original or various types of cameras, or a PC (personal computer), and data is represented by an RGB (red, green, blue)-component color signal in general. In the image digitalization, as described above, image data is generated as an RGB signal, and when being output as a visible image, the image data is converted into outputtable data. If the image data is output to a printer or the like to print out the image on a paper medium, the output data is usually represented by a CMYK (cyan, magenta, yellow, black)-component color signal to correspond to color developing materials (ink, toner, etc.) used in printing.

Based on such a situation, there is a printer accepting only RGB data as the input color space. If one wants to output CMYK data as original data to such a printer, the original CMYK data needs to be converted into RGB data to meet the input color space. In this case, if the original CMYK data to be converted includes data formed of only K or data formed of mostly K and a small amount of CMY, and a color conversion process of such data into RGB is performed, for example, within a client PC, an unintended RGB conversion is performed in an OS or application on the side of the PC, and as an output result, there may be a case where it is not possible to output the data with only K or a case where the degradation of the image quality occurs, such as a noticeable splash of toner due to an increase in an amount of CMY.

Conventional technologies proposing a means or a method for suppressing the degradation of an image by performing a color conversion process depending on an output device include Japanese Patent Application Laid-open No. H10-164380 and Japanese Patent Application Laid-open No. 2005-191841.

Japanese Patent Application Laid-open No. H10-164380 discloses a method for assigning output colors that an output device can output to colors used in input image data so that colors of a line and a text, which are supposed to be output in different colors, are not be the same, and can be clearly distinguished.

Japanese Patent Application Laid-open No. 2005-191841 discloses a method for reserving a holding area in an area of a look-up table holding a correspondence relationship between an input image signal value and an output image signal value where any input image signal values cannot be located, holding a specific color signal value (for example, achromatic color) in the holding area, and performing a conversion of an address to the holding area if the input image signal value is achromatic color, thereby outputting a specific color signal value corresponding to the input image.

However, in the technology disclosed in Japanese Patent Application Laid-open No. H10-164380, if the number of colors that the output device can output is limited as compared with variations of input color signals, a change in the image quality of an entire image may occur in the process not to assign the same color. Furthermore, in the technology disclosed in Japanese Patent Application Laid-open No. 2005-191841, the process different from the usual color conversion process, such as the address conversion, is implemented, so a processing step for this process is added, and the processing load is increased, which leads eventually to a problem of a decrease in the processing speed.

### SUMMARY OF THE INVENTION

It is an object of the present invention to at least partially solve the problems in the conventional technology.

According to an aspect of the present invention, there is provided an image processing apparatus that performs a color conversion process on an input RGB-component color signal into an output color signal with a color conversion table. The color conversion table is a combined color conversion table that a regular-use color conversion table and an adjustment color conversion table are combined. The image processing apparatus includes, as a unit for generating the adjustment color conversion table, a change necessity determining unit configured to use a dummy color conversion table containing input RGB values and no-conversion output values being equal to their corresponding input RGB values to determine whether a no-conversion output value in the dummy color conversion table needs to be changed based on whether an input RGB value meets a predetermined change condition; and an output-value changing unit configured to change the no-conversion output value corresponding to the input RGB value that has been determined to meet the change condition by the change necessity determining unit to an output value, each color component of which has a same or almost same value, to thereby generate the adjustment color conversion table.

According to another aspect of the present invention, there is provided a method for generating a color conversion table used in a color conversion process performed on an input RGB-component color signal. The method includes first acquiring a hue H, a saturation S, and a lightness value V based on an input RGB value of the input RGB-component color signal; second acquiring a brightness Y based on the input RGB value of the input RGB-component color signal; first determining whether the lightness value V obtained at the first acquiring is smaller than a predetermined lower limit; first changing a no-conversion output value in a dummy color conversion table containing input RGB values and no-conversion output value being equal to their corresponding input RGB values, to another output value based on the hue H obtained at the first acquiring and the brightness Y obtained at the second acquiring when the lightness value V is determined to be smaller than the predetermined lower limit at the first determining; second determining whether the lightness value V obtained at the first acquiring is larger than a predetermined upper limit;

second changing the no-conversion output value in a dummy color conversion table based on the hue H acquired at the first acquiring and the brightness Y acquired at the second acquiring when the lightness value V is determined to be larger than the predetermined upper limit at the second determining; third determining whether the saturation S obtained at the HSV acquiring step is smaller than a predetermined lower limit of a phase angle divided section corresponding to the hue H obtained at the first acquiring when the lightness value V is determined to be not smaller than the predetermined lower limit at the first determining and the lightness value V is determined to be not larger than the predetermined upper limit at the second determining; third changing the no-conversion output value in the dummy color conversion table based on the hue H obtained at the first acquiring and the brightness Y obtained at the second acquiring when the saturation S is determined to be smaller than the predetermined lower limit at the third determining; and generating a combined color conversion table by combining the dummy color conversion table in which the no-conversion output value has been changed at the first to third changing with a regular-use color conversion table.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram illustrating a configuration of an image processing system according to an embodiment of the present invention;

FIGS. 2A and 2B are schematic diagrams of a color conversion table used in a color conversion from RGB to R′G′B′;

FIGS. 3A and 3B are HSV color space diagrams illustrating a target range of black adjustment by the color conversion;

FIG. 4 is a flowchart of a process of generating a color conversion table according to the embodiment of the present invention;

FIGS. 5A and 5B are color space diagrams illustrating a change in an output RGB value in a dummy color conversion table that is changed for black adjustment; and

FIGS. 6A and 6B are conceptual diagrams of a table combining process for generating a combined color conversion table by combining the to-be-combined color conversion table and a normal-use color conversion table.

### DETAILED DESCRIPTION OF THE PREFERRED EMBODIMENTS

Exemplary embodiments of an image forming apparatus (a printer, a multifunction product, etc.) to which an image processing apparatus and a method for generating a color conversion table according to the present invention are applied are explained below with reference to the accompanying drawings.

(Overview of Image Processing System)

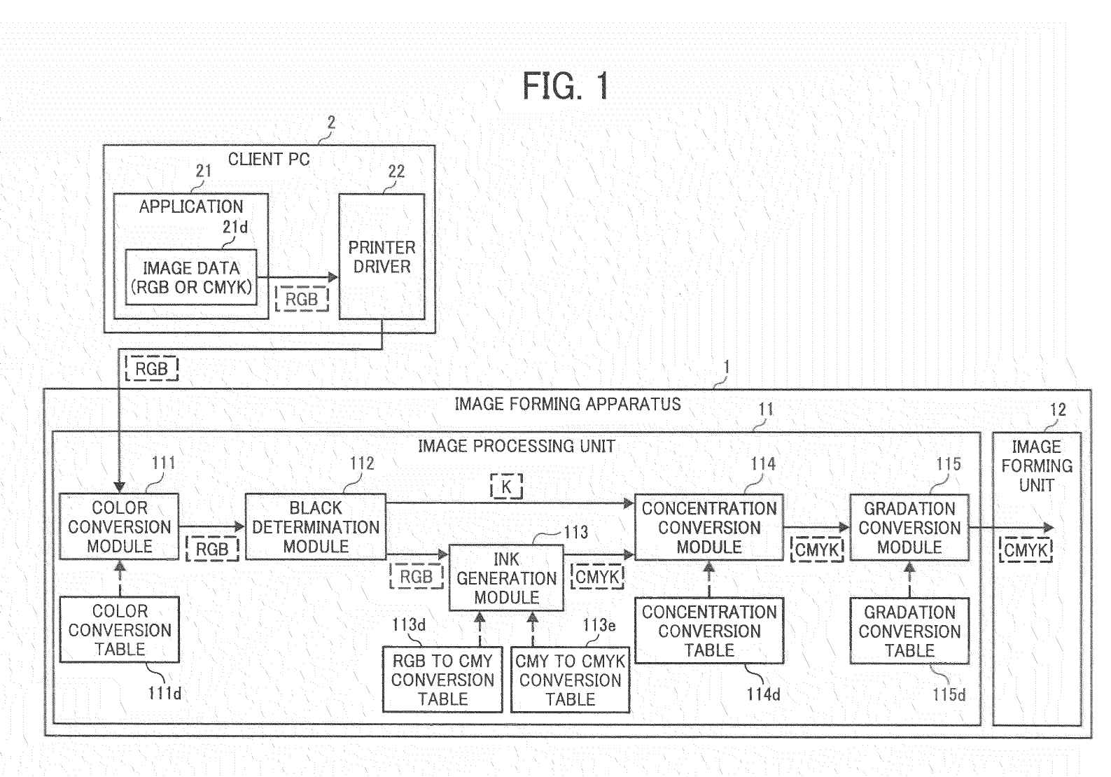

FIG. 1 is a block diagram illustrating a configuration of an image processing system according to an embodiment. FIG. 1 shows a configuration example of the image processing system composed of a client PC 2 and an image forming apparatus 1. In this example, the image forming apparatus 1 receives a print command transmitted from the client PC 2, and performs a print output (an image forming process) using image data attached to the print command.

In FIG. 1, image data 21d in the RGB or CMYK color space is generated by application 21 in the client PC 2.

If a printer driver 22 in the client PC 2 or the image forming apparatus 1 is configured to accept only RGB as the input color space (input color signals to the printer driver 22 and the image forming apparatus 1 are denoted by “RGB” in FIG. 1), and image data to be processed is CMYK, a color conversion from CMYK to RGB is performed by the application 21 or an OS (operating system) in the client PC 2.

When the printer driver 22 receives RGB image data, the printer driver 22 adds information, such as the output resolution specified by a user, to the data, and transmits a print command to which the image data is attached to the image forming apparatus 1.

The image forming apparatus 1 includes an image processing unit 11 and an image forming unit 12. When the image forming apparatus 1 receives the print command from the client PC 2, the image forming apparatus 1 conducts a color conversion from input RGB to output CMYK through a color conversion module 111, a black determination module 112, an ink generation module 113, a concentration conversion module 114, and a gradation conversion module 115 in the image processing unit 11, and outputs CMYK image data as print data to the image forming unit 12.

The color conversion module 111 performs a conversion from input RGB to R′G′B′ with a color conversion table 111d. The R′G′B′ is RGB data depending on an output device (a print engine of the image forming unit 12, in this case), and is data adapted to be input to a subsequent CMYK conversion. Incidentally, in this embodiment, a combined color conversion table to be described in detail below is used as the color conversion table 111d in the color conversion module 111, whereby a function of adjusting an achromatic color image (particularly, an image in black or color close to black used in a text, a line, etc.) is added.

The black determination module 112 is configured to output only K or output R′G′B′. The black determination module 112 determines whether values of respective color components (R, G, B components) of an input color signal are identical to one another, and when the values of the R, G, B components are identical to one another (R=G=B), the black determination module 112 sets values of the C, M, Y, components at 0 (C=M=Y=0) and a value of the K component at a predetermined value as input data values to the concentration conversion module 114. When the values of the R, G, B components are not identical to one another (other than R=G=B), with the input values of the R, G, B components set as output values, the black determination module 112 sets the input values of the R, G, B components as output values, and inputs the values of the R, G, B components to the ink generation module 113.

The ink generation module 113 generates CMYK (including only K) from the input R, G, B with an RGB to CMY conversion table 113d and a CMY to CMYK conversion table 113e, and sets the CMYK as input data values to the concentration conversion module 114.

The concentration conversion module 114 performs a gamma correction depending on the output device for each color of CMYK (only K in a case of K single color) with a concentration conversion table 114d, and sets the corrected CMYK as input data values to the gradation conversion module 115.

The gradation conversion module 115 performs a gradation process depending on the output device with a gradation conversion table 115d, and outputs the processed CMYK to the output device (the print engine of the image forming unit 12, in this case).

In the image processing unit 11 of the image forming apparatus 1 shown in FIG. 1, the above-mentioned modules 111 to 115 and tables 111d to 115d and the like are configured with a hardware module, and their operations are controlled under the control of a CPU (not shown), thereby enabling the operation for the output image processing described above. The modules operating under the control of the CPU can be configured with software instead of hardware.

The image processing unit 11 configured with software can be realized by a program for making a computer composed of a CPU, a RAM (random access memory) and a ROM (read only memory) which operate under the control of the CPU, and the like serve as the image processing unit 11. At the time of execution of a process, the CPU loads a control and processing program and the like which are recorded (stored) in the ROM into the RAM as a working memory, and drives the program and the like, whereby the CPU (the computer) can be made to serve as a means for executing the process. Incidentally, a medium for recording the program is not limited to the ROM; alternatively, other computer-readable recording media, such as an HDD, a CD (compact disk)-ROM, an MO (magnet optical disk), and a DVD (digital versatile disk), can be used. Furthermore, the program can be stored on a computer connected to a network (not shown), such as the Internet, and provided by being downloaded via the network.

Incidentally, in FIG. 1, the color conversion module 111 and the color conversion table 111d can be held only on the side of the printer driver 22 in the client PC 2, and an output from the printer driver 22 can be used as an input value to the black determination module 112 of the image forming apparatus 1.

Furthermore, the color conversion module 111 and the color conversion table 111d can be held on both the side of the printer driver 22 in the client PC 2 and the side of the image forming apparatus 1, and depending on an amount of data, a color conversion can be performed only on the side of the printer driver 22, or a color conversion can be performed only on the side of the image forming apparatus 1.

Subsequently, the color conversion process performed by the color conversion module 111 is explained in detail below.

The color conversion module 111 according to this embodiment achieves two functions by performing the color conversion process on input RGB color data values.

One of the functions is a function of correcting the input RGB data by converting the input RGB data into R′G′B′ data depending on the output device (the print engine of the image forming unit 12, in this case), and is the existing function that can be achieved by the color conversion module. Incidentally, the color conversion table 111d is used in the color conversion module 111; this method is widely used in color conversion processing, and is a method employed in a color conversion from RGB to R′G′B′.

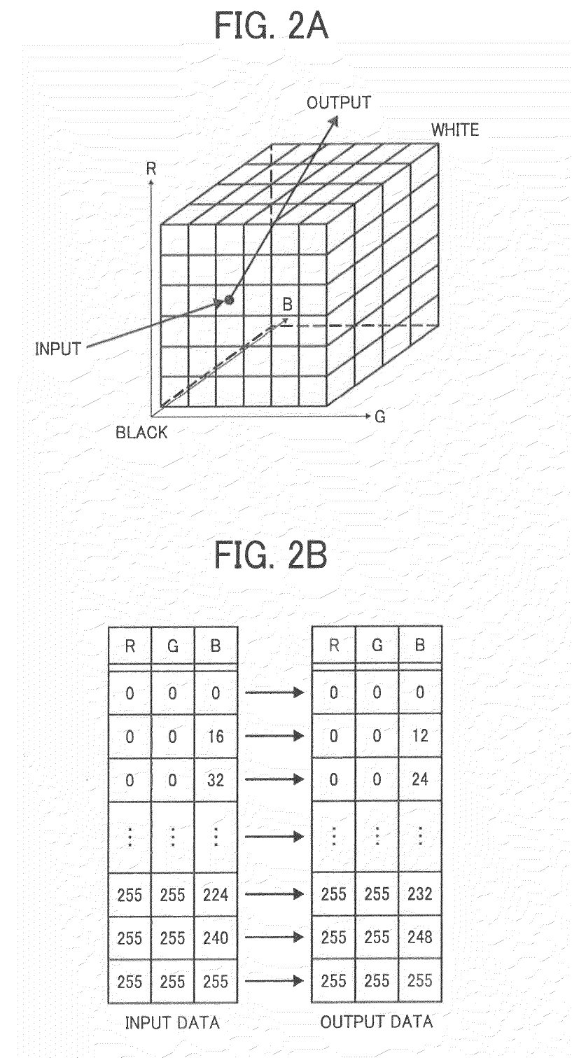

FIGS. 2A and 2B are is a schematic diagrams of a color conversion table used in the color conversion process performed on input RGB. FIG. 2A shows a three-dimensional coordinate system representing RGB values; an origin of the three-dimensional coordinate system represents black, and a point farthest from the origin (i.e., a point having the maximum RGB value) represents white. A value on a grid point of a cube expressed on the three-dimensional coordinate system represents data included in the table as an input RGB value shown in FIG. 2B. Intervals between grid points are arbitrary. Each of the grid points holds data on an output RGB value (R′G′B′, in the present embodiment) in a manner corresponding to an input RGB value as shown in FIG. 2B. When the color conversion table is used in the conversion process, if an input RGB value do not fit onto any of the grid points, output RGB values in the table cannot be used directly, so a corresponding output RGB value is obtained by performing an interpolation calculation based on an output RGB value of a nearby grid point.

In this manner, by reference to the color conversion table, a unique output RGB value with respect to the input RGB value is obtained.

The other function achieved by the conversion performed on the input RGB color data values is a function added in this embodiment, and is a function of adjusting a color data value of an achromatic image, especially, an image in black or color close to black used in a text, a line, or the like (hereinafter, referred to as a “black adjustment function”).

The black adjustment function is an adjustment function to cope with the degradation of the image quality that may occur in the following case. Namely, if one causes an output device that performs a print output with only RGB data as the input color space to output CMYK as original data, the original CMYK data needs to be converted into RGB to meet the input color space. In this case, if the original CMYK data to be converted includes data formed of only K or data formed of mostly K and a small amount of CMY, and a color conversion process of such data into RGB is performed, for example, within the OS or the application of the client PC, when the data subjected to the color conversion process is used in the output device, there may be a case where it is not possible to output the data with only K or a case where the degradation of the image quality occurs in an image in black or color close to black, such as a noticeable splash of toner due to an increase in an amount of CMY.

By suppressing such degradation of the image quality and making the image in black or color close to black more blackish, the adjustment of color data for improving the image quality is achieved by the function.

(Combined Color Conversion Table)

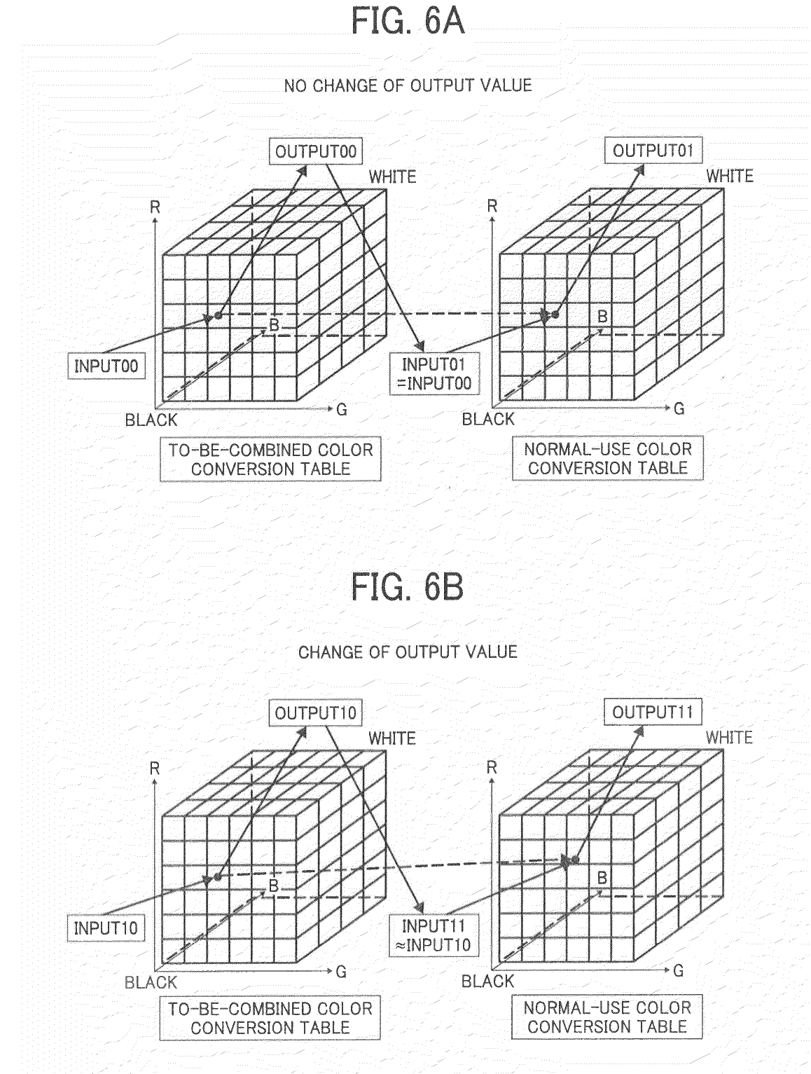

In this embodiment, the color conversion process for achieving the black adjustment function is performed by the method using the existing color conversion table (see FIGS. 2A and 2B), which is employed in the color conversion process for achieving the function of correcting characteristics (conditions) of the output device as a method for the color conversion process. As an embodiment, a combined color conversion table that the color conversion table for correcting characteristics of the output device, which is normal use (hereinafter, referred to as a “normal-use color conversion table” or a “regular-use color conversion table”) and the color conversion table for the black adjustment function (hereinafter, referred to as a “black-adjustment color conversion table”) are combined is generated, and the generated combined color conversion table is used (see the explanation of FIGS. 6A and 6B to be described below). By using such a means, based on the method established as a conversion processing method, a processing means for achieving the two functions described above can be made up without adding a particular process in practice.

(Black-Adjustment Color Conversion Table)

Table data in the existing color conversion table is that output RGB values are set to correspond to input RGB values in the form as explained with reference to FIGS. 2A and 2B, and is stored in the color conversion table 111d in advance, and managed in the referable form so as to be referenced when the color conversion module 111 receives an input color signal and executes the process. In the case of the black-adjustment color conversion table, table data is managed in that form.

In a case of the color conversion for black adjustment, a color conversion for adjusting a color data value of an achromatic image, especially, an image in black or color close to black used in a text, a line, or the like to make the image more blackish is performed. Accordingly, the black-adjustment color conversion table is composed of table data for converting the input RGB value set in advance as an adjustment target to a changed output RGB value, each R, G, B color component or which has the same or almost the same value. The input RGB values and the adjusted RGB output will be described in detail in “Color-conversion-table generating process” below.

(Color-Conversion-Table Generating Process)

A method for generating the color conversion table 111d used in the color conversion process by the color conversion module 111 (FIG. 1) is explained.

As described above, the color conversion module 111 uses the combined color conversion table that the regular-use color conversion table (the color conversion table for correcting characteristics/conditions of the output device, which is normal use) and the black-adjustment color conversion table are combined in the color conversion process.

In the color conversion process performed for correcting characteristics of the output device with the regular-use color conversion table in the color conversion module 111, considering temporal change of device characteristics, it is appropriate to employ the method of generating the table within the image forming apparatus 1 to maintain the precision. In this point of view, as for the black-adjustment color conversion table, it is preferable that a data value in the black-adjustment color conversion table can be changed depending on a relationship with characteristics of the output device, a user use condition, or the like.

Consequently, in this embodiment, a means for processing the generation of the color conversion table (combined color conversion table) 111d used in the color conversion process performed by the color conversion module 111 is provided in the image forming apparatus 1, and it is configured that conditions for the generation of the color conversion table can be changed in accordance with a change in device conditions of the image forming apparatus 1 or a user's judgment so as to perform the optimum color conversion process.

The image forming apparatus 1 includes, as a controller responsible for the control of the entire apparatus, a computer (not shown) composed of a CPU, and a RAM, a ROM, and the like which operate under the control of the CPU, so the color-conversion-table generating process can be implemented by building up a color-conversion-table generation processing unit in the controller.

Incidentally, it is also possible to implement the color-conversion-table generating process by the way to use an external color-conversion-table generation processing means. For example, in a case where the image forming apparatus 1 is connected to a management server via a LAN (local area network), and devices in the image forming apparatus 1 are monitored by the management server, and a system capable of managing the operating status is made up, the management server can perform the process of generating the color conversion table, and the generated color conversion table can be stored in the color conversion table 111d of the image forming apparatus 1 via the LAN.

In the method of generating the combined color conversion table, using a dummy color conversion table containing input RGB values and no-conversion output values being equal to their corresponding input RGB values, it is determined whether a no-conversion output RGB value in the dummy color conversion table needs to be changed based on whether an input RGB value of the input RGB-component color signal is the predetermined input RGB value that is set as a target of black adjustment.

When it is determined that the input RGB value is the predetermined input RGB value, i.e., a non-converted output value in the dummy color conversion table needs to be changed, the no-conversion output RGB value in the dummy color conversion table is changed to an output RGB value, each R, G, B color component of which has the same or almost same value.

(Targets of black adjustment (i.e., range of input RGB values whose output RGB values need to be changed))

In this embodiment, as the targets of black adjustment, the input RGB values whose output values need to be changed includes black or color close to black used in a text, a line, or the like, and is in a range indicated by the following cases 1 to 3. Incidentally, in the present embodiment, if an input RGB value is achromatic color (for example, R=G=B), an output RGB value in the dummy color conversion table is not to be changed, so in any of the following cases 1 to 3, the input RGB value is in a range of chromatic color (for example, R=G=B is not met).

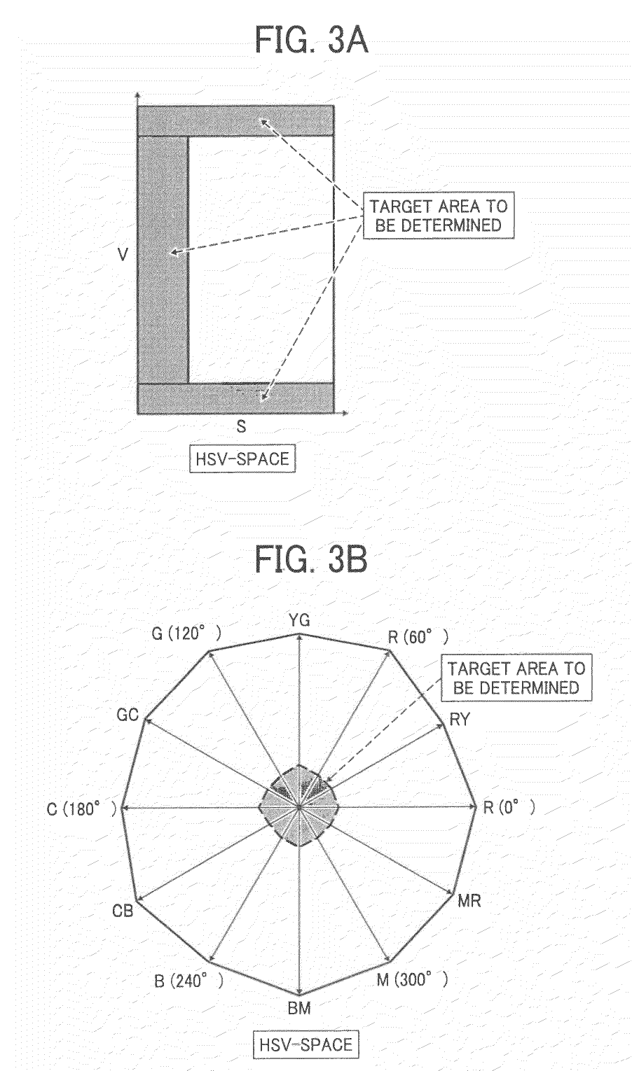

1. When a lightness value (calculated from the input RGB value) is larger than a predetermined upper limit (see the explanation of FIG. 3A described below).

2. When the lightness value is smaller than a predetermined lower limit (see the explanation of FIG. 3A described below).

3. When a saturation value (calculated from the input RGB value) is smaller than a saturation value given to a divided section of the hue angle to which a hue value calculated from the input RGB value belongs out of predetermined saturation values given to respective divided sections of the hue angle (see the explanations of FIGS. 3A and 3B described below).

The hue, the saturation, and the lightness value can be calculated by using the existing conversion equations based on an RGB value.

The range of the input RGB values whose output RGB values need to be changed, as indicated in the above cases 1 to 3, is explained with reference to the drawing depicting the color space.

FIGS. 3A and 3B are HSV (H: hue, S: saturation, V: lightness value) color space diagrams illustrating a target range of black adjustment. An area indicated as a target area to be determined (a dotted portion) in FIG. 3A is an area where the lightness value V and the saturation S meet any of the following conditions (1) to (3).

(1) The lightness value V is larger than a predetermined upper limit.

(2) The lightness value V is smaller than a predetermined lower limit.

(3) The saturation S is smaller than a predetermined value.

If any of the above conditions (1) and (2) is met, it is in a range subject to black adjustment (the conditions (1) and (2) correspond to the above cases 1 and 2, respectively). The area looks achromatic color even if a value of the saturation S is close to the maximum value, so only the lightness value V is used as the criteria for determining.

Furthermore, there is an area that does not meet any of the above conditions (1) and (2) but meets the above condition (3) that the saturation S is smaller than a predetermined value; as for this area, the predetermined value (lower limit) of the saturation S is set based on the relationship with the hue H. The lower limit is, as shown in FIG. 3B, the hue H is indicated by a hue angle of 0° to 360°, so the target area to be determined (the dotted portion) is determined based on a value of the saturation S (in a range of 0 to 1) of each divided section of the hue angle (corresponding to the above case 3.). As for a range of the target area to be determined, a threshold of the lightness value V can be changed when toner in color other than black is noticeable because it is light color (faint color when printed on paper).

(Calculation of output RGB value to be replaced with no-conversion output RGB value)

In any of the above cases 1 to 3, a no-conversion output RGB value in the dummy color conversion table is changed to an output value, each R, G, B color component of which has the same or almost the same value; as a method for calculating the value, in this embodiment, using any of the following methods A and B, the output value is calculated on the basis of a brightness value Y (a value of the YUV brightness) of the input RGB value. Incidentally, the brightness value Y can be calculated by using the existing conversion equation based on the RGB value.

A. In a case of conversion into achromatic color: A brightness value Y calculated from the input RGB value is normalized to 0 to 255 (black to white), and an output RGB value of achromatic color is obtained by “R=Y×α, G=R, B=R” on the basis of the obtained brightness value Y. A value of α is normally 1; however, if one wants the output RGB value to be wholly light, a value of α is set to less than 1, so that a desired result is obtained.

B. In a case of conversion into color other than achromatic color: A brightness value Y calculated from the input RGB value is normalized to 0 to 255 (black to white), and an achromatic color value is calculated in the same manner as in the above case 1 on the basis of the obtained brightness value Y (the calculated values are referred to as “R1, G1, B1”). After that, based on the input RGB value (referred to as “R0, G0, B0”) and the calculated achromatic color value, an output RGB value, each R, G, B color component of which is almost the same is obtained by using the equations “R=(R0-R1)/β+R1, G=(G0-G1)/β+G1, B=(B0-B1)/β+B1”. A value of β is normally 2; however, when one wants to reduce a difference from the normal color conversion, a value of β is set to less than 2, so that a desired result is obtained.

A value calculated by any of the above methods is replaced with the no-conversion output RGB value in the dummy color conversion table, thereby generating the black adjustment color conversion table (i.e., a “to-be-combined” color conversion table that is to be combined with the normal-use color conversion table). By using the black adjustment color conversion table, a color data value of an image in color close to black can be adjusted to be more blackish.

(Flow of Color-Conversion-Table Generating Process)

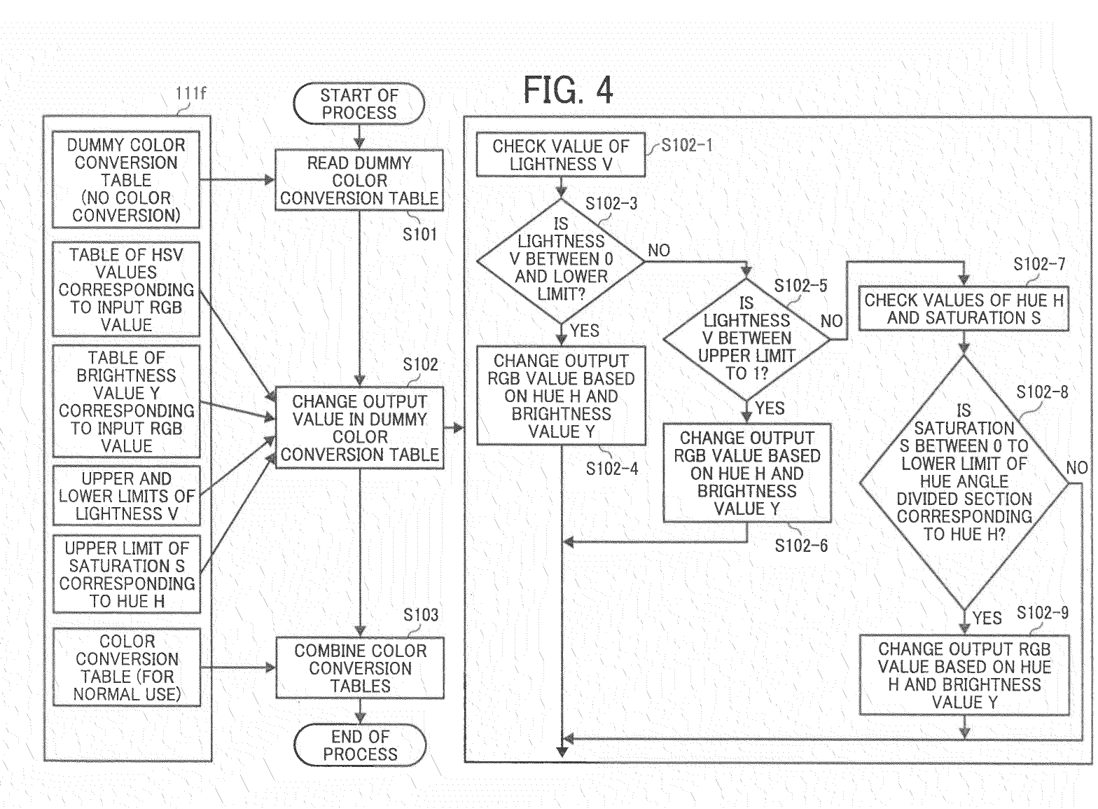

Subsequently, processing procedures in generation of the color conversion table are explained with reference to a process flow shown in FIG. 4. Incidentally, in this embodiment, the controller (not shown) of the image forming apparatus 1 executes the process in accordance with the generation processing method of which the overview is described in above “Color-conversion-table generating process”. Thus, before execution of the process, the following data A to F required for the process is acquired, and managed in a table-generation database (DB) 111f so that the data can be used.

A. Dummy color conversion table (no-conversion table)

B. Table of HSV (H: hue, S: saturation, V: lightness value) values corresponding to input RGB value

C. Table of Y (brightness) value corresponding to input RGB value

D. Predetermined upper and lower limits of lightness value V (see the above explanation of FIG. 3A defining a processing target range)

E. Predetermined upper limit of saturation S corresponding to hue H (see the above explanation of FIGS. 3A and 3B defining the processing target range)

F. Normal-use color conversion table (color conversion table for correcting characteristics of output device)

When the process flow shown in FIG. 4 is started, first, as a part of a combined color conversion table generated in this process, a dummy color conversion table subjected to a process to be used for black adjustment is read from the table-generation DB 111f (Step S101). In the dummy color conversion table, an input RGB value and an output RGB value are the same value, and no color conversion is made. Only one dummy color conversion table is read. Incidentally, as will be described below, a normal-use color conversion table to be combined is prepared for each drawing object; however, a dummy color conversion table is shared among drawing objects, so one dummy color conversion table is read, and just a one-time generating process is required.

Subsequently, an output RGB value (a no-conversion output RGB value) in the dummy color conversion table to be combined read at Step S101 is changed in accordance with a table generating condition, and the dummy color conversion table (no-conversion table) is changed to a black adjustment color conversion table (Step S102). Before this process of changing the output RGB value is performed, as data used for determining whether the output RGB value needs to be changed, the above-mentioned data B to E is read from the table-generation DB 111f.

The process of changing the output RGB value at Step S102 is performed in accordance with a subsequence of steps shown on the right side of FIG. 4. Incidentally, the subsequence is a process of changing an output RGB value in the dummy color conversion table in the state where no color conversion is made, so basically, the subsequence is performed on each of input RGB values as many as the number of grid points of the dummy color conversion table, i.e., the subsequence is repeatedly performed on each of the input RGB values until the processes on all the grid points are completed.

In the subsequence at Step S102, first, a (lightness) value V of an input RGB value to be processed is acquired from the HSV table (Step S102-1), and the acquired value is compared with a predetermined lower limit to check whether the lightness value V is smaller than the predetermined lower limit (Step S102-3). If the lightness value V is smaller than the lower limit (YES at Step S102-3), the condition for determining that the output RGB value needs to be changed (hereinafter, referred to as the “change condition”) is met, so an output RGB value is calculated on the basis of a brightness value Y of the input RGB value acquired from the Y table, and the output RGB value in the dummy color conversion table is changed to the calculated value, thereby generating the to-be-combined color conversion table (Step S102-4). Incidentally, the calculation of the output RGB value is performed as described in “Calculation of output RGB value to be replaced with no-conversion output RGB value” above.

After that, when completion of the process of generation of the to-be-combined color conversion table is confirmed, the subsequence is exited.

At Step S102-3, if the lightness value V is larger than the lower limit (NO at Step S102-3), the lightness value V of the input RGB value to be processed is compared with a predetermined upper limit to check whether the lightness value V is larger than the predetermined upper limit (Step S102-5). If the lightness value V is larger than the upper limit (YES at Step S102-5), the change condition is met, so an output RGB value is calculated on the basis of a brightness value Y of the input RGB value, and the output RGB value in the dummy color conversion table is changed to the calculated value, thereby generating the to-be-combined color conversion table (Step S102-6). After that, when completion of the process of generation of the to-be-combined color conversion table is confirmed, the subsequence is exited.

At Step S102-5, if the lightness value V is smaller than the upper limit (NO at Step S102-5), a hue H and a saturation S of the input RGB value are acquired from the HSV table, and also a predetermined lower limit of the saturation S corresponding to the hue H is obtained (Step S102-7), and then a value of the acquired saturation S is compared with the predetermined lower limit to check whether the saturation S is smaller than the predetermined lower limit (Step S102-8). If the saturation S is smaller than the lower limit (YES at Step S102-8), the change condition is met, so an output RGB value is calculated on the basis of a brightness value Y of the input RGB value acquired from the Y table, and the output RGB value in the dummy color conversion table is changed to the calculated value, thereby generating the to-be-combined color conversion table (Step S102-9). After that, when completion of the process of generation of the to-be-combined color conversion table is confirmed, the subsequence is exited.

On the other hand, at Step S102-8, if the saturation S is larger than the lower limit (NO at Step S102-8), the process on the input RGB value to be processed is terminated without changing the output RGB value. After that, when completion of the process of generation of the to-be-combined color conversion table is confirmed, the subsequence is exited.

By performing the process of changing an output RGB value at Step S102, generation of the to-be-combined color conversion table performed in accordance with the table generating condition is completed. Next, the to-be-combined color conversion table thus completed is combined with a normal-use color conversion table (a color conversion table for correcting characteristics of the output device) read from the table-generation DB 111f, thereby generating a combined color conversion table (Step S103). At this time, the normal-use color conversion table to be combined is prepared for each drawing object, so the normal-use color conversion table corresponding to each drawing object is combined with the to-be-combined color conversion table generated at Step S102, which is shared among the drawing objects, thereby generating the combined color conversion table for each drawing object.

After the combined color conversion table is generated, the process flow is terminated.

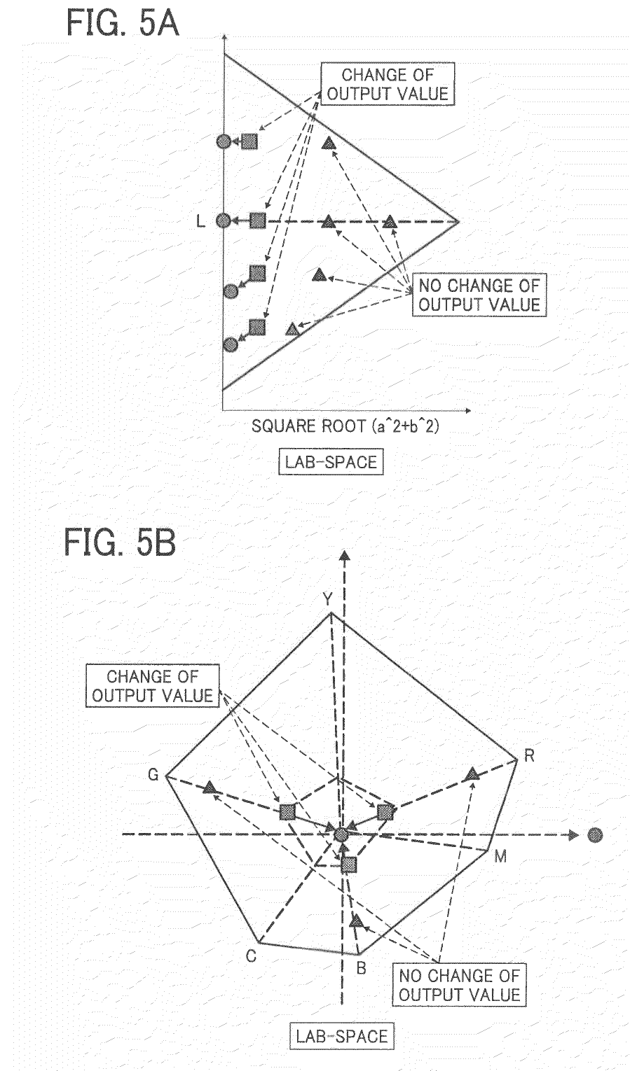

FIGS. 5A and 5B are color space diagrams illustrating a change in an output RGB value in the dummy color conversion table that is changed at Step S102 for black adjustment.

FIGS. 5A and 5B shows a change in an output value on a Lab color space conceptually. In FIG. 5A, it shows that an output value of high saturation color (denoted by a triangle in the diagram) is not changed, and an output value of low saturation color (denoted by a square in the diagram) is changed in the direction of lowering the saturation. The change of color is made by changing an output value on the basis of a brightness value Y; in FIG. 5A, it shows that an output value of low-saturation and bright color is changed in the direction of retaining the lightness, and an output value of low-saturation and dark color is changed in the darkening direction.

FIG. 5B shows an example where an output value of high saturation color (denoted by a triangle in the diagram) is not changed, and an output value of low saturation color (denoted by a square in the diagram) is changed in the direction of lowering the saturation. In the example shown in FIG. 5B, it shows that a degree of change in an output value of blue (B) is kept low even if it is color to be changed, and as for red (R) and green (G), color to be changed is changed to almost achromatic color. As for the hue of a target area to be determined, under the condition of the sRGB color space, if RGB conversion is performed on data of 0% to 100% K in a CMYK image created by application, a hue value of color around red to yellow is shown in most cases, so with respect to around red to yellow, an area of achromatic color output is widened as compared with that of the hue around blue.

(Black Adjustment Depending on Hue)

In above “Targets of black adjustment (range of input RGB values whose output RGB values need to be changed)”, the determination whether an input RGB value is one of which the corresponding output RGB value needs to be changed as an object of black adjustment is made on the basis of the lightness value and the saturation.

However, as described in FIG. 5B, in consideration of the hue, an area requiring a change of an output RGB value in the relationship with the hue (an area of achromatic color output determined by the saturation is widened in around red to yellow as compared with that is in around blue) or a degree of change in an output value (a low degree in blue, red and green are changed to almost achromatic color) is moderated, and therefore, it is possible to make a more effective black adjustment.

In this embodiment, as a method for obtaining the same effect on black adjustment corresponding to a hue as above, two examples of embodiments of the method for improving the image quality by directly performing adjustment depending on a hue are described below.

### Embodiment 1

One of the embodiments is a method of changing an output RGB value with an area around a predetermined hue value as a target range. Namely, a hue value is calculated from an input RGB value, and an area where the calculated hue value is a value around the predetermined hue value is set as an area requiring a change of an output RGB value.

Furthermore, with respect to the area, the output RGB value is changed such that each difference between R, G, B component values of the changed output RGB value is smaller than that of the input RGB value. In other words, the output RGB value is changed so that conversion is performed not to turn into complete achromatic color but to be close to achromatic color more moderately. For example, with respect to blue and color around blue, conversion making it close to achromatic color is performed.

### Embodiment 2

The other embodiment is a method of changing an output RGB value with an area other than the area around the predetermined hue value as a target range. Namely, a hue value is calculated from an input RGB value, and an area where the calculated hue value is a value other than the value around the predetermined hue value is set as an area requiring a change of an output RGB value.

Furthermore, with respect to the area, the output RGB value is changed to an output RGB value, each R, G, B color component of which is the same value (R=G=B), i.e., converted to an output RGB value of achromatic color. For example, blue and color around blue are set as a predetermined hue, and conversion making read and green, color other than the hue, achromatic color is performed.

Incidentally, the above embodiments 1 and 2 can be implemented either separately or simultaneously.

In this manner, the adjustment corresponding to the hue is performed by the methods described in the above embodiments 1 and 2, whereby it is possible to reduce a gradation boundary with peripheral color that may occur in a document having different image characteristics due to a mixture of a plurality of drawing objects.

(Response to Drawing Object)

As described above, the normal-use color conversion table is a color conversion table for correcting characteristics of the output device, and in a conventional technology, color conversion tables fitting into respective drawing objects are prepared on an object-by-object basis.

Consequently, as for the normal-use color conversion table composing the combined color conversion table, to ensure a process fitting into a drawing object, in the same manner as in the conventional technology, a color conversion table corresponding to each drawing object is introduced, and a combined color conversion table is generated.

As a color conversion table fitting into a drawing object used in this embodiment, color conversion tables corresponding to drawing objects generated by the application 21 of the client PC 2 are used. Thus, it is appropriate that the color conversion tables correspond to three drawing objects: (1) a photo/image object, (2) a rectangle/graphic object, and (3) a character/text object, respectively. However, the present invention is not limited to these color conversion tables for the three objects, and the number of color conversion tables can be increased or reduced depending on a capacity or use of the ROM included in the image forming apparatus (the image processing apparatus).

(Generation of Combined Color Conversion Table)

As described above, normal-use color conversion tables for respective drawing objects are prepared, and combined color conversion tables are generated for each drawing object. The combined color conversion table is generated by combining the to-be-combined color conversion table with the normal-use color conversion table. In the process of generating the combined color conversion table, first, both of the tables are generated. The process of combining the tables includes pre-processing of generating the to-be-combined color conversion table generated by changing an output RGB value in a change target area in a dummy color conversion table, and post-processing of combining the to-be-combined color conversion table with the normal-use color conversion table for each drawing object is generated as post-processing.

By performing the pre-processing and the post-processing of the generating process, the process of generating the to-be-combined color conversion table, which is shared among the objects in a table combining process, can be made at once; thus, the process can be effectively performed.

FIGS. 6A and 6B are conceptual diagrams of a table combining process for generating a combined color conversion table by combining a to-be-combined color conversion table and a normal-use color conversion table.

A process of generating the to-be-combined color conversion table generated by changing an output RGB value in a change target area in a dummy color conversion table is performed as pre-processing, and a process of combining the to-be-combined color conversion table with the normal-use color conversion table corresponding to a drawing object is performed as post-processing.

When the identical to-be-combined color conversion table is combined with the color conversion table for each drawing object, as shown in FIGS. 6A and 6B, if an input RGB value to the to-be-combined color conversion table is a value outside of the change target area, as shown in FIG. 6A, the input RGB value and a corresponding output RGB value in the to-be-combined color conversion table generated in the pre-processing are equal to an input RGB value in normal-use color conversion table to be used in the post-processing.

On the other hand, if an input RGB value to the combining color conversion table is a value within the change target area, as shown in FIG. 6B, only a corresponding output RGB value in the to-be-combined color conversion table generated in the pre-processing is equal to an input RGB value in the normal-use color conversion table to be used in the post-processing.

According to an aspect of the present invention, by the application of a combined color conversion table using color conversion tables based on a method established as a color-conversion processing method for adjusting the image quality, the image quality of an achromatic color image, especially, an image in black or color close to black used in a text, a line, or the like can be improved, and the image quality of the entire image can be improved, and furthermore, the same processing load and processing speed as in the conventional method using a color conversion table can be maintained.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image processing apparatus that performs a color conversion process on an input RGB-component color signal into an output color signal with a color conversion table, wherein
the color conversion table is a combined color conversion table that a regular-use color conversion table and an adjustment color conversion table are combined, and
the image processing apparatus comprises, as a unit for generating the adjustment color conversion table:
a change necessity determining unit configured to use a dummy color conversion table containing input RGB values and no-conversion output values being equal to their corresponding input RGB values to determine whether a no-conversion output value in the dummy color conversion table needs to be changed based on whether an input RGB value meets a predetermined change condition; and
an output-value changing unit configured to change the no-conversion output value corresponding to the input RGB value that has been determined to meet the change condition by the change necessity determining unit to an output value, each color component of which has a same or almost same value, to thereby generate the adjustment color conversion table.

2. The image processing apparatus according to claim 1, wherein the change necessity determining unit is configured to calculate a lightness value from the input RGB value, and determine that the no-conversion output value needs to be changed when the lightness value is larger than a predetermined upper limit.

3. The image processing apparatus according to claim 1, wherein the change necessity determining unit is configured to calculate a lightness value from the input RGB value, and determine that the no-conversion output value needs to be changed when the lightness value is smaller than a predetermined lower limit.

4. The image processing apparatus according to claim 1, wherein the change necessity determining unit is configured to calculate a saturation value and a hue value from the input RGB value, and determine that the no-conversion output value needs to be changed when the calculated saturation value is smaller than a saturation value given to a divided section of a hue angle to which the calculated hue value belongs out of predetermined saturation values given to respective divided sections of the hue angle.

5. The image processing apparatus according to claim 1, wherein
the change necessity determining unit is configured to calculate a hue value from the input RGB value, and determine that the no-conversion output value needs to be changed when the calculated hue value is a value around a predetermined hue value, and
the adjustment color conversion table is a color conversion table for converting the input RGB value to an output value in which each difference between respective color component values of the output value is smaller than that of the input RGB value.

6. The image processing apparatus according to claim 1, wherein
the change necessity determining unit is configured to calculate a hue value from the input RGB value, and determine that the no-conversion output value needs to be changed when the calculated hue value is not a value around a predetermined hue value, and
the adjustment color conversion table is a color conversion table for converting the input RGB value to an output value, each color component of which has the same value.

7. The image processing apparatus according to claim 1, further comprising a table generating unit configured to generate the combined color conversion table for each drawing object.

8. The image processing apparatus according to claim 7, wherein the drawing object is at least any one of an image object, a graphic object, and a text object.

9. The image processing apparatus according to claim 7, wherein the table generating unit is configured to perform generation of the adjustment color conversion table as pre-processing, and perform combining the adjustment color conversion table with the regular-use color conversion table for each drawing object as post-processing.

10. A method for generating a color conversion table used in a color conversion process performed on an input RGB-component color signal, the method comprising:
first acquiring a hue H, a saturation S, and a lightness value V based on an input RGB value of the input RGB-component color signal;
second acquiring a brightness Y based on the input RGB value of the input RGB-component color signal;
first determining whether the lightness value V obtained at the first acquiring is smaller than a predetermined lower limit;
first changing a no-conversion output value in a dummy color conversion table containing input RGB values and no-conversion output value being equal to their corresponding input RGB values, to another output value based on the hue H obtained at the first acquiring and the brightness Y obtained at the second acquiring when the lightness value V is determined to be smaller than the predetermined lower limit at the first determining;
second determining whether the lightness value V obtained at the first acquiring is larger than a predetermined upper limit;
second changing the no-conversion output value in a dummy color conversion table based on the hue H acquired at the first acquiring and the brightness Y acquired at the second acquiring when the lightness value V is determined to be larger than the predetermined upper limit at the second determining;
third determining whether the saturation S obtained at the HSV acquiring step is smaller than a predetermined lower limit of a phase angle divided section corresponding to the hue H obtained at the first acquiring when the lightness value V is determined to be not smaller than the predetermined lower limit at the first determining and the lightness value V is determined to be not larger than the predetermined upper limit at the second determining;
third changing the no-conversion output value in the dummy color conversion table based on the hue H obtained at the first acquiring and the brightness Y obtained at the second acquiring when the saturation S is determined to be smaller than the predetermined lower limit at the third determining; and
generating a combined color conversion table by combining the dummy color conversion table in which the no-conversion output value has been changed at the first to third changing with a regular-use color conversion table.
